(19) United States
(12) Patent Application Publication
(10) Pub. No.: US 2013/0287532 A1
(43) Pub. Date: Oct. 31, 2013

(54) Transporting Device for Substrate

(71) Applicants: Yunshao Jiang, Shenzhen (CN); Chunhao Wu, Shenzhen (CN); Kunhsien Lin, Shenzhen (CN); Yongqiang Wang, Shenzhen (CN); Zhiyou Shu, Shenzhen (CN); Minghu Qi, Shenzhen (CN); Xiande Li, Shenzhen City (CN); Zhenhua Guo, Shenzhen City (CN); Weibing Yang, Shenzhen City (CN); Zenghong Chen, Shenzhen City (CN)

(72) Inventors: Yunshao Jiang, Shenzhen (CN); Chunhao Wu, Shenzhen (CN); Kunhsien Lin, Shenzhen (CN); Yongqiang Wang, Shenzhen (CN); Zhiyou Shu, Shenzhen (CN); Minghu Qi, Shenzhen (CN); Xiande Li, Shenzhen City (CN); Zhenhua Guo, Shenzhen City (CN); Weibing Yang, Shenzhen City (CN); Zenghong Chen, Shenzhen City (CN)

(73) Assignee: SHENZHEN CHINA STAR OPTOELECTRONICS TECHNOLOGY CO., LTD., Shenzhen, Guangdong (CN)

(21) Appl. No.: 13/511,180

(22) PCT Filed: May 8, 2012
(86) PCT No.: PCT/CN2012/075174

§ 371 Date: May 22, 2012

(30) Foreign Application Priority Data
Apr. 27, 2012 (CN) 201210129129.3

(51) Int. Cl. B65G 49/05

(52) U.S. Cl. 414/749.1

(57) ABSTRACT

A transporting device for liquid crystal display module (LCM) is provided and includes a platform for carrying the liquid crystal display module. The platform includes a plurality of supporting racks arranged in parallel along a first direction. A trolley is configured with a base installed with a plurality of fingers extending along the first direction. A driving device is used to manipulate the trolley. The transportation device is beneficial for automation of the LCM production. During the transportation, the LCM along with its printed circuit pattern is fully supported by the trolley and all the hindrance resulted from the loosely arranged printed circuit pattern can be successfully resolved.

### FIELD OF THE INVENTION

The present invention relates to transporting device for substrate, and more particularly to a transporting device which can automatically carrying liquid crystal display panels of different dimensions during the assembling stage of the manufacturing processes.

### DESCRIPTION OF PRIOR ART

During a later stage of manufacturing of a typical Thin-Film-Transistor Liquid Crystal Display (TFT-LCD), after the printed circuit patterns are laminated on the peripheral borders of the LCD panel, the liquid crystal display module (LCM) will be transferred to another workstations for later process by means of moving stand or trolley. Currently, the LCM is transferred by manually or by a pick-and-place device having a nozzle to facilitate the transportation.

Since the dimensions of the LCM vary, and even using labor to move the LCM is still workable for the LCM production lines, it is not cost-effective as moving manually consumes a great deal of time. In addition, the larger the dimension of the LCM, the heavy it is, and it is not a good practice to have it carried manually as accident may happen resulted from errors resulted from the weight of the LCM.

Of course, using the pick-and-place device to transfer the LCM increases performance, however, the printed circuit patterns along the borders can not be touched or altered during handling. As a result, during the transportation, the printed circuit pattern has to be hanged over and these loosely arranged printed circuit pattern will inevitably after the handling of the LCM because care has to be taken to avoid any damage or alternation to those printed circuit pattern.

Accordingly, it is necessary to provide a transporting device for LCM so as to resolve the problem encountered by the prior art.

### SUMMARY OF THE INVENTION

It is an objective of this invention to provide an automatic transporting device to readily and conveniently transport the LCM from stages to stages.

In order to resolve the prior art problem, a technical solution is introduced by the present invention by providing a transporting device for liquid crystal display module (LCM). The transporting device comprises a platform for carrying the liquid crystal display module, and includes a plurality of supporting racks arranged in parallel along a first direction, a pitch between every two adjacent supporting racks being adjustable. A trolley is provided and configured with a base installed with a plurality of fingers extending along the first direction. A pitch of the fingers across the base is adjustable. A driving device is used to manipulating the trolley to and from the platform in a way that the fingers can extend into space between the supporting racks of the platform so as to transport the LCM supported on the supporting racks. The trolley includes a first guiding device along the first reference direction, and the supporting racks are moveably disposed on the first guiding device. The platform includes a second guiding device along the first reference direction, and the supporting racks being moveably disposed on the second guiding device.

Wherein the first guiding device includes a pair of first rails and the fingers are moveably disposed the pair of first rails.

Wherein the first rails are marked with calibers.

Wherein the second guiding device includes a pair of second rails and the supporting racks are moveably enveloped the pair of second rails.

Wherein a thickness of the supporting racks of the platform along a vertical direction is larger than a thickness of the fingers of the trolley.

Wherein the fingers are provided with positioning device for securely positioning the LCM supported thereon.

Wherein the positioning device includes a first nozzle interconnected with a first circuit, and a second nozzle interconnected with a second circuit, the first and second nozzles located on the same finger are in ling with each other, the first and second nozzles located on the same finger are distant from each other.

Wherein the driving device is a robot arm.

In order to resolve the prior art problem, a technical solution is introduced by the present invention by providing a transporting device for liquid crystal display module (LCM). The transporting device comprises a platform for carrying the liquid crystal display module, and includes a plurality of supporting racks arranged in parallel along a first direction. A pitch between every two adjacent supporting racks is adjustable. A trolley is configured with a base installed with a plurality of fingers extending along the first direction. A pitch of the fingers across the base is adjustable. A driving device is used to manipulate the trolley to and from the platform in a way that the fingers can extend into space between the supporting racks of the platform so as to transport the LCM supported on the supporting racks.

Wherein the trolley further includes a first guiding device along the first reference direction, and the fingers are moveably disposed on the first guiding device.

Wherein the first guiding device includes a pair of first rails and the fingers are moveably disposed the pair of first rails.

Wherein the first rails are marked with calibers.

Wherein the platform further includes a second guiding device along the first reference direction, and the supporting racks are moveably disposed on the second guiding device.

Wherein the second guiding device includes a pair of second rails and the supporting racks are moveably enveloped the pair of second rails.

Wherein a thickness of the supporting racks of the platform along a vertical direction is larger than a thickness of the fingers of the trolley.

Wherein the fingers are provided with positioning device for securely positioning the LCM supported thereon.

Wherein the positioning device includes a first nozzle interconnected with a first circuit, and a second nozzle interconnected with a second circuit, the first and second nozzles located on the same finger are in ling with each other, the first and second nozzles located on the same finger are distant from each other.

Wherein the driving device is a robot arm.

The present invention can be concluded with the following advantages which the prior art fails to demonstrate. As compared to the prior art, the platform of the transporting device can temporally support the LCM, and then the LCM can be readily picked up by the fingers of the trolley to another proper workstation by means of the driving device. This is an automatic operation. In addition, during the transportation, the printed circuit pattern located aside of the liquid crystal display panel are also securely supported by the fingers of the trolley. As a result, transportation of the LCM, both pick up and laying down, will not be hindered by the printed circuit pattern.

### DESCRIPTION OF DRAWINGS

FIG. 1 is a perspective view of a transporting device made in accordance with the present invention;

FIG. 2 is an illustrational view showing a LCM is carried a platform of the transporting device;

FIG. 3 is an illustrational view showing the LCM in FIG. 2 is transferred to fingers of a trolley of the transporting device;

FIG. 4 is an illustrational view showing how the LCM is transported by the trolley;

FIG. 5 is a top view of the platform and the trolley of the transporting device;

FIG. 6A is an illustrational view of a linear rail; and

FIG. 6B discloses the linear rail is marked with calibers.

### DETAILED DESCRIPTION OF PREFERRED EMBODIMENT

Detailed description of preferred embodiment will be given along with the accompanied drawings.

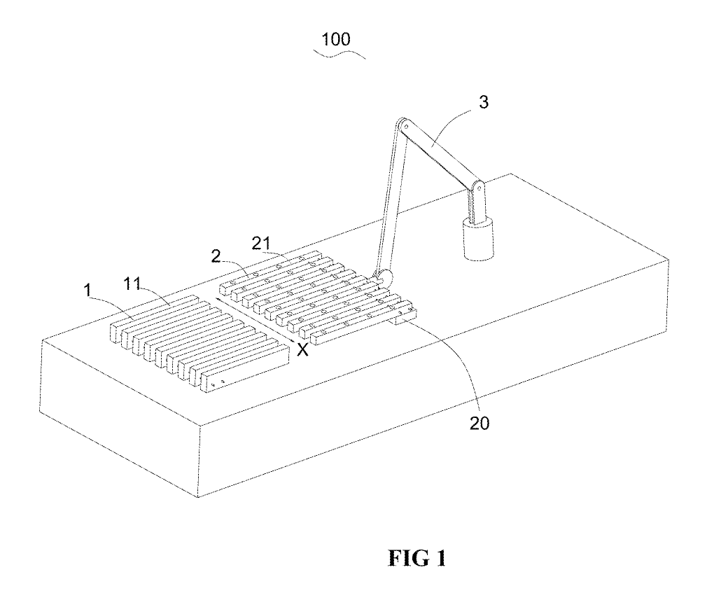

Referring to FIG. 1, the transporting device 100 is configured with a platform 1, a trolley 2, and a driving device 3.

The platform 1 is used to carry a liquid crystal display module (LCM) 4 which includes a LCD panel 41, and printed circuit pattern 42 arranged on the peripheral of the panel 41. The platform 1 includes a plurality of supporting racks 11 arranged in parallel along a first direction X. A pitch between every two adjacent supporting racks 11 is adjustable. The trolley 2 is provided and configured with a base 20 installed with a plurality of fingers 21 extending along the first direction X. A pitch of the fingers across the base is also adjustable.

In the field application, the supporting racks 11 are adjusted to a suitable pitch in accordance with the dimension of the LCD 4 to be transported. Meanwhile, the pitch of the fingers 21 on the base 20 is also adjusted. Then the LCD 4 is disposed on the platform 1 and waits for being transported.

In the present invention, the platform I is used as a temporal storage, and is cooperating with the trolley 2. Since different batches of LCMs 4 could be different, and when the transporting device 100 is used to transport the LCDs 4 with small dimensions, the pitch of both the supporting racks 11 and the fingers 21 can be adjusted accordingly. This pre-adjustment of both the supporting racks 11 and the lingers 21 can readily prevent any mishandling or loss of balance of the LCMs 4 resulted from improper pitch, for example, too large for a small LCM 4. If the LCMs 4 with larger dimension are to be transported, then the pitch of both the supporting racks 11 and the fingers 21 can be enlarged so as to match the dimension LCD 4 along the first direction X. By enlarging the pitch of both the supporting racks 11 and the fingers 21, damaging resulted from mishandling from small pitch can be avoided.

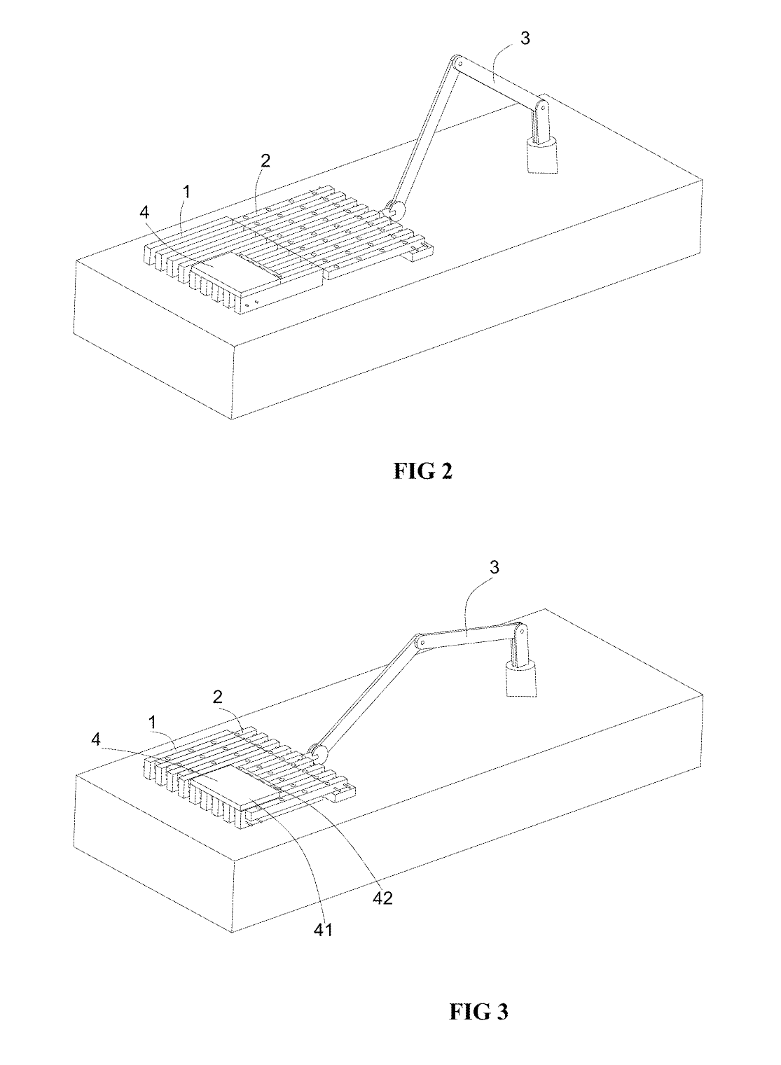

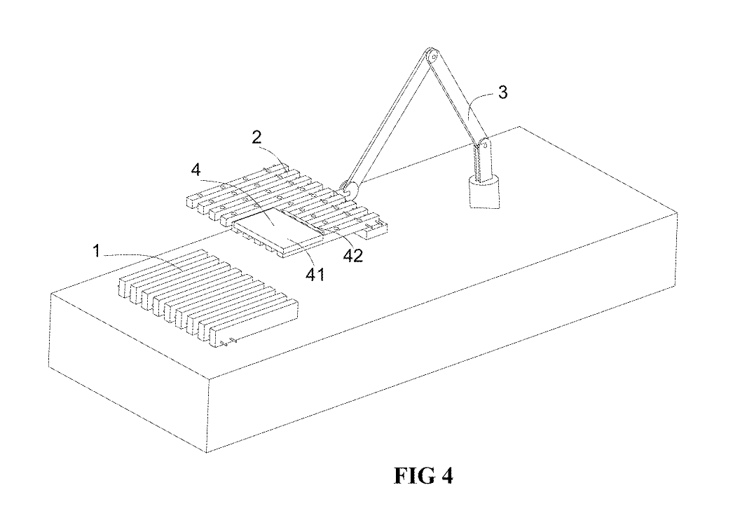

The driving device 3 is used to manipulate the movement of the trolley 2 in a way that portion of the fingers 21 can extend into the space between the supporting racks 11. As a result, the fingers 21 of the trolley 2 can readily lift up the LCM 4 supported by the platform 1, and move it to other proper workstation. This can be preferably depicted from FIGS. 2 to 4. Referring now to FIG. 5, the fingers 21 further include a guiding device 22 along the first reference direction X and which is located on the base 20. Those fingers 21 are moveably arranged on the guiding device 22. The platform 1 is provided with a guiding device 12 along the first reference direction X, the supporting racks 11 are also movably arranged onto the guiding device 12. In the preferred embodiment, the guiding devices 12, 22 are configured by a pair of linear rails 120, 220, and the supporting racks 11 and the fingers 21 are all moveably supported onto the linear rails 120, 220. Since this is a skill well known to the skilled in the art, and there are also other alternatives and substitutes. However, any alternative or alternations will also be covered by the accompanied claims.

The guiding device 22 can pass through a center of a thickness of the fingers, as shown in FIGS. 1 to 5. Alternatively, the guiding device 22 can be fixedly disposed on the base 20 or integrally formed with the base 20. The base 20 is located under the fingers 21. For example, a sliding slot and rail (not shown) can be arranged between the base 20 and the guiding device 22. By this arrangement, the pitch of the finger 21 of the trolley 2 can be adjusted to match with the dimension of the LCM 4.

The guiding device 12 is preferably arranged on ends of the supporting racks 11 distant to the trolley 2. This arrangement will prevent the fingers 21 of the trolley 2 from colliding with the guiding device 12 when the fingers 21 are moved into the space between the supporting racks 11. Any inconvenience resulted therefrom is properly avoided. Furthermore, the guiding device 12 is preferably arranged closely to a bottom of the supporting racks 11. When a thickness of the supporting racks 11 is selectively larger than the thickness of the fingers 21, this will further prevent the lingers 21 from colliding with the guiding device 2 when the fingers 21 move into the space between the supporting racks 11.

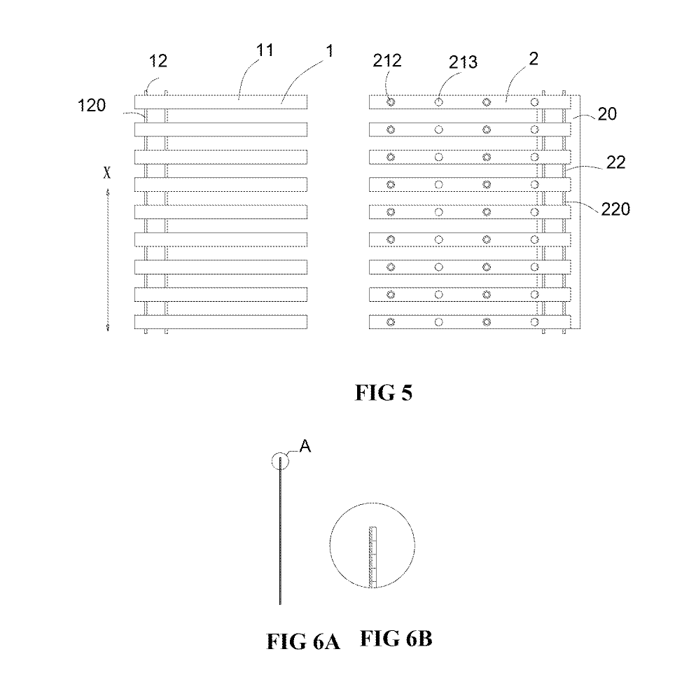

Referring to FIGS. 6A and 6B, in order to accurately adjust the pitch of the fingers 11 and the supporting racks 21, the linear racks 120 and 220 can be marked with calibers so as to promptly and quickly adjust the pitch. Once the pitch of the supporting racks 11 and the fingers 21 can be accurately adjusted to properly support the LCM 4 during transportation.

During the transportation of the LCM 4, in order to prevent the LCM 4 supported by the fingers 21 of the trolley 2 from tilting or falling ff, each of the fingers 21 is further provided with a positioning device 211 for securely holding of the LCM 4. Referring to FIG. 5, in this preferred embodiment, the positioning device 211 includes a first nozzle 212 interconnected with a first circuit, and a second nozzle 213 interconnected with a second circuit. The first and second nozzles 212, 213 located on the same finger 21 are in ling with each other, and the first and second nozzles 212, 213 are distant from each other. The first nozzle 212 is interconnected to a first vacuum circuit (not shown), and the second nozzle 213 is interconnected to the second vacuum circuit (not shown).

When the LCM 4 is to be picked up by the fingers 21 of the trolley 2, both the first and second nozzles 212, 213 will exert a vacuum to securely hold up the LCM 4 onto the fingers 21 of the trolley 2. In use, if a single vacuum circuit can not serve its intended purpose, a second circuit can be powered on so as to exert additional sucking force to the LCM 4 so as to securely hold up the LCM 4 onto the fingers 21 of the trolley 2. Accordingly, safety and stability of the LCM 4 are both ensured during transportation of the LCM 4 by the transporting device 100. Any damaging resulted from tilting or falling off can be successfully avoided. Yield as well as performance is also ensured.

Referring to FIGS. 1 to 5, the driving device 3 is a robot arm. The driving device 3 is interconnected to the base 20 of the trolley 2 and moves the fingers 21 of the trolley 2 into the space between the supporting racks 11 of the platform 1 so as to remove the LCM 4 out of the platform 1.

The present invention can be concluded with the following advantages which the prior art fails to demonstrate. The platform 1 of the transporting device 100 can temporally support the LCM 4, and then the LCM 4 can be readily picked up by the fingers 21 of the trolley 2 to another proper workstation by means of the driving device 3. This is an automatic operation. In addition, during the transportation, the printed circuit pattern 42 located aside of the liquid crystal display panel 41 are also securely supported by the fingers 21 of the trolley 2. As a result, transportation of the LCM. 4, both pick up and laying down, will not be hindered by the printed circuit pattern 42.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the clams of the present invention.

1. A transporting device for liquid crystal display module (LCM), comprising:
a platform for carrying the liquid crystal display module, and including a plurality of supporting racks arranged in parallel along a first direction, a pitch between every two adjacent supporting racks being adjustable;
a trolley configured with a base installed with a plurality of fingers extending along the first direction, a pitch of the fingers across the base being adjustable;
a driving device used to manipulate the trolley to and from the platform in a way that the fingers can extend into space between the supporting racks of the platform so as to transport the LCM supported on the supporting racks;
the trolley including a first guiding device along the first reference direction, and the supporting racks being moveably disposed on the first guiding device; and
the platform including a second guiding device along the first reference direction, and the supporting racks being moveably disposed on the second guiding device.

2. The transporting device as recited in claim 1, wherein the first guiding device includes a pair of first rails and the fingers are moveably disposed the pair of first rails.

3. The transporting device as recited in claim 2, wherein the first rails are marked with calibers.

4. The transporting device as recited in claim 1, wherein the second guiding device includes a pair of second rails and the supporting racks are moveably enveloped the pair of second rails.

5. The transporting device as recited in claim 1, wherein a thickness of the supporting racks of the platform along a vertical direction is larger than a thickness of the fingers of the trolley.

6. The transporting device as recited in claim 1, wherein the fingers are provided with positioning device for securely positioning the LCM supported thereon.

7. The transporting device as recited in claim 1, wherein the positioning device includes a first nozzle interconnected with a first circuit, and a second nozzle interconnected with a second circuit, the first and second nozzles located on the same finger are in ling with each other, the first and second nozzles located on the same finger are distant from each other.

8. The transporting device as recited in claim 1, wherein the driving device is a robot arm.

9. A transporting device for liquid crystal display module (LCM), comprising:
a platform for carrying the liquid crystal display module, and including a plurality of supporting racks arranged in parallel along a first direction, a pitch between every two adjacent supporting racks being adjustable;
a trolley configured with a base installed with a plurality of fingers extending along the first direction, a pitch of the fingers across the base being adjustable; and
a driving device used to manipulate the trolley to and from the platform in a way that the fingers can extend into space between the supporting racks of the platform so as to transport the LCM supported on the supporting racks.

10. The transporting device as recited in claim 9, wherein the trolley further includes a first guiding device along the first reference direction, and the fingers are moveably disposed on the first guiding device.

11. The transporting device as recited in claim 10, wherein the first guiding device includes a pair of first rails and the fingers are moveably disposed the pair of first rails.

12. The transporting device as recited in claim 11, wherein the first rails are marked with calibers.

13. The transporting device as recited in claim 10, wherein the platform further includes a second guiding device along the first reference direction, and the supporting racks are moveably disposed on the second guiding device.

14. The transporting device as recited in claim 13, wherein the second guiding device includes a pair of second rails and the supporting racks are moveably enveloped the pair of second rails.

15. The transporting device as recited in claim 9, wherein a thickness of the supporting racks of the platform along a vertical direction is larger than a thickness of the fingers of the trolley.

16. The transporting device as recited in claim 9, wherein the fingers are provided with positioning device for securely positioning the LCM supported thereon.

17. The transporting device as recited in claim 16, wherein the positioning device includes a first nozzle interconnected with a first circuit, and a second nozzle interconnected with a second circuit, the first and second nozzles located on the same finger are in ling with each other, the first and second nozzles located on the same finger are distant from each other.

18. The transporting device as recited in claim 9, wherein the driving'device is a robot arm.
